(19) United States
(12) Patent Application Publication
(10) Pub. No.: US 2025/0348182 A1
(43) Pub. Date: Nov. 13, 2025

(54) METHOD FOR ESTABLISHING SOFTWARE AUGMENTED REALITY AND SOFTWARE AUGMENTED AGENT SYSTEM

(71) Applicant: IsCoolLab Co., Ltd., Taipei City (TW)

(72) Inventor: YAN-MEI JIANG, Taipei City (TW)

(21) Appl. No.: 18/657,933

(22) Filed: May 8, 2024

(51) Int. Cl. G06F 3/0481; G06F 3/0484; G06F 9/451

(52) U.S. Cl. CPC G06F 3/0481; G06F 3/0484; G06F 9/451; G06F 2203/04804

(57) ABSTRACT

A method for establishing a software augmented agent and a software augmented agent system are provided. The method is adapted to an electronic device. The electronic device is connected to a display device. The electronic device includes an application program. At least one an interaction interface of the application program is displayed on the display device. The method includes the following steps: providing an augmented interface based on the interaction interface of the application program; displaying at least one augmented parameter of the augmented interface based on at least one corresponding acquisition information of at least one interaction parameter of the at least one interaction interface; and adjusting at least one augmented parameter displayed on the augmented interface based on variations in the corresponding acquisition information of the at least one interaction parameter of the at least one interaction interface.

### FIELD OF THE DISCLOSURE

The present disclosure relates to a method for establishing a software and a software system, and more particularly to a method for establishing a software augmented agent and a software augmented agent system.

### BACKGROUND OF THE DISCLOSURE

Application programs in electronic devices are usually developed according to customer requirements or market demands. After the development is completed, if the original developer does not revise the functions, there is no way to update other functions of the application program without obtaining the source code.

However, even if the same set of applications is used, users in different fields will have different functional requirements.

### SUMMARY OF THE DISCLOSURE

In response to the above-referenced technical inadequacies, the present disclosure provides a method for establishing software augmented agent. The method for establishing a software augmented agent is adapted to an electronic device. The electronic device is connected to a display device. The electronic device includes an application program. At least one interaction interface of the application program is displayed on the display device. The method includes the following steps: providing an augmented interface based on the interaction interface of the application program; displaying at least one augmented parameter of the augmented interface based on at least one corresponding acquisition information of the at least one interaction parameter of the at least one interaction interface; and adjusting the at least one augmented parameter displayed on the augmented interface based on variations in the at least one corresponding acquisition information of the at least one interaction parameter of the at least one interaction interface.

In order to solve the above-mentioned problems, one of the technical aspects adopted by the present disclosure is to provide a software augmented agent system. The software augmented agent system is adapted for an electronic device. The electronic device is connected to at least one display device. The electronic device includes a control circuit, a storage circuit and a display circuit. The electronic device also includes an application program, which is provided in the storage circuit. The application program includes an interaction interface. The control circuit displays the interaction interface on the display device through the display circuit. The software augmented agent system includes an augmented application program provided in the storage circuit. The control circuit displays an augmented interface on the display device through the application program and the augmented application program. The augmented interface and the interaction interface are both displayed on the display device.

Therefore, in the method for establishing a software augmented agent and the software augmented agent system provided by the present disclosure, by virtue of “providing an augmented interface based on the interaction interface of the application program,” and “the software augmented agent system including an augmented application program provided in the storage circuit,” the method for establishing a software augmented agent and the software augmented agent system provided by the present disclosure are not required to communicate with the underlying code of the application program, and by obtaining the corresponding acquisition information through the interaction interface of the application program, the augmented parameter of the augmented interface is determined. Furthermore, the method for establishing a software augmented agent and the software augmented agent system of the present disclosure can effectively improve the efficiency of software development and enhance the user experience.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for establishing a software augmented agent according to a first embodiment of the present disclosure;

FIG. 2 is a schematic view of a system adapted to the method for establishing a software augmented agent according to the first embodiment of the present disclosure;

FIG. 3 is a schematic view of the method for establishing a software augmented agent according to the first embodiment of the present disclosure;

FIG. 4 is another schematic view of the method for establishing a software augmented agent according to the first embodiment of the present disclosure;

FIG. 5 is yet another schematic view of the method for establishing a software augmented agent according to the first embodiment of the present disclosure;

FIG. 6 is a schematic view of a software augmented agent system according to a second embodiment of the present disclosure;

FIG. 7 is a schematic view of a software augmented agent system according to a third embodiment of the present disclosure; and

FIG. 8 is a schematic view of a software augmented agent system according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

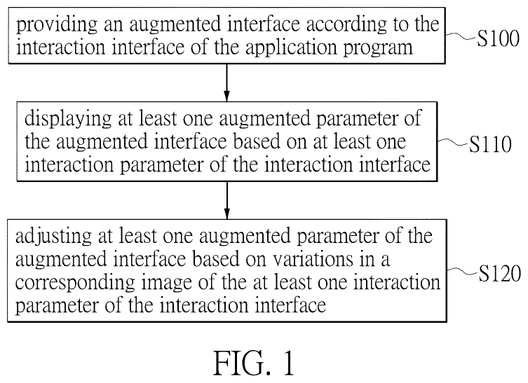

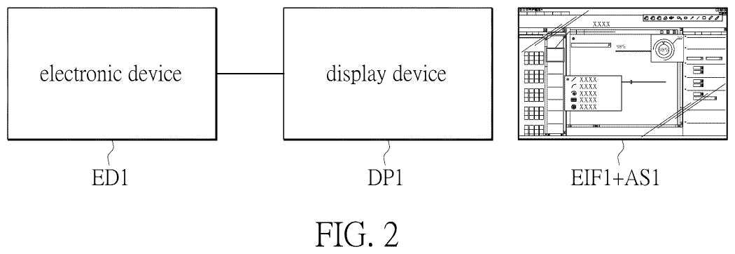

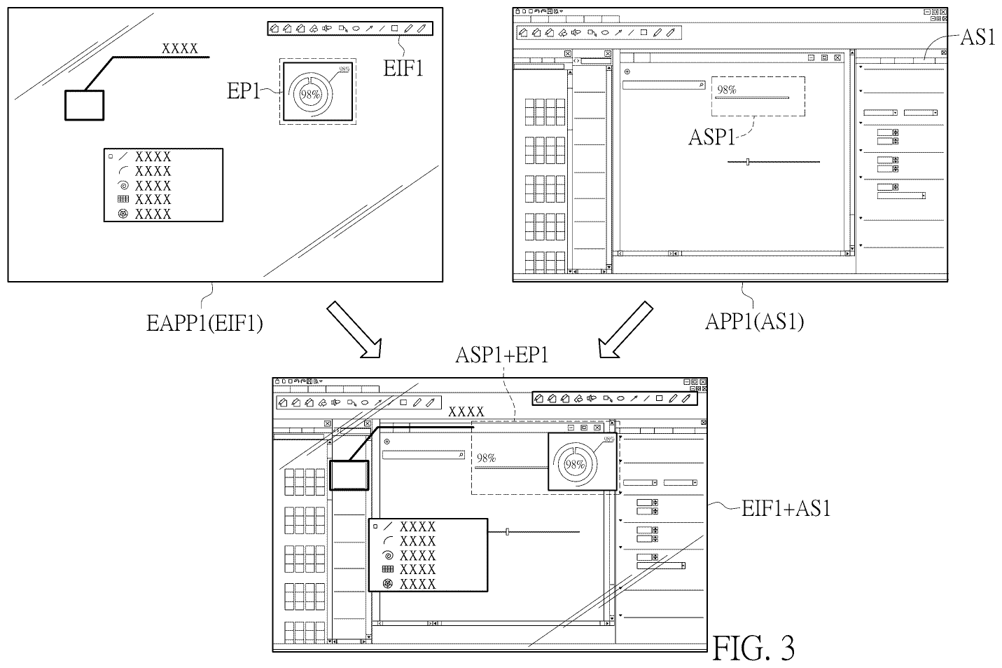

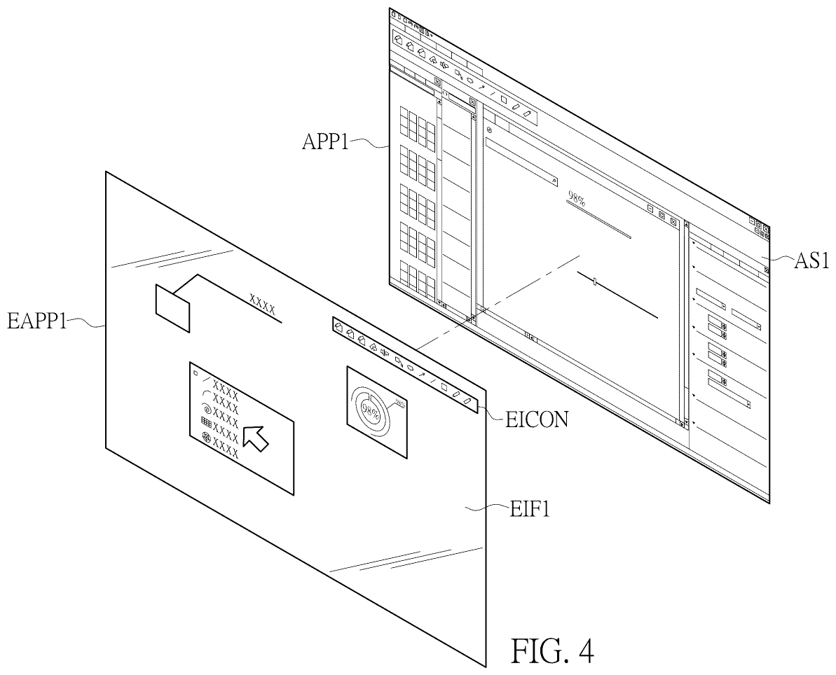

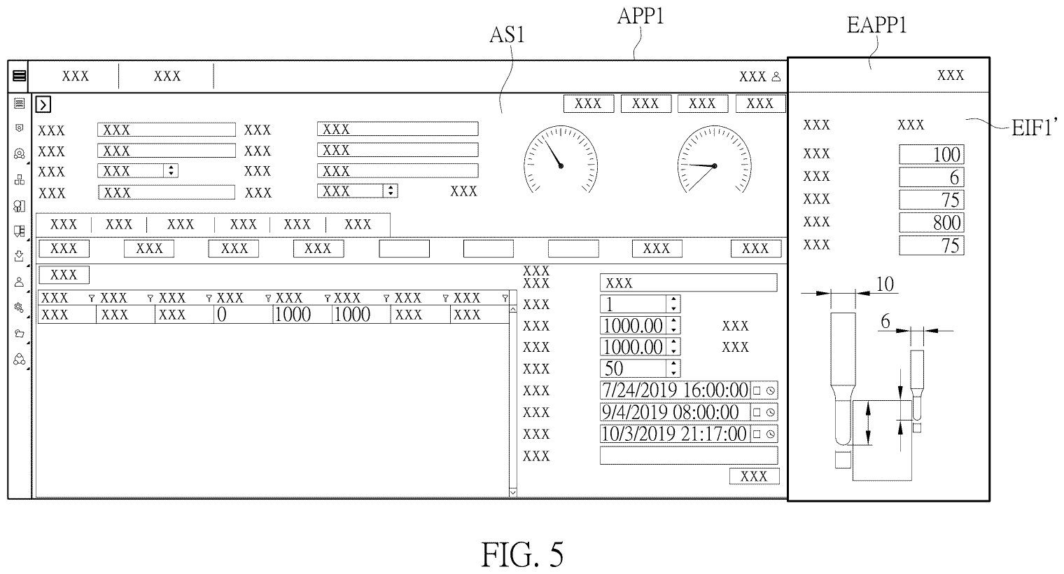

Referring to FIG. 1, FIG. 2, FIG. 3, FIG. 4, and FIG. 5, a first embodiment of the present disclosure provides a method for establishing software augmented agent.

FIG. 1 is a flowchart of a method for establishing a software augmented agent according to a first embodiment of the present disclosure.

FIG. 2 is a schematic view of a system adapted to the method for establishing a software augmented agent according to the first embodiment of the present disclosure. FIG. 3 is a schematic view of the method for establishing a software augmented agent according to the first embodiment of the present disclosure. FIG. 4 is another schematic view of the method for establishing a software augmented agent according to the first embodiment of the present disclosure. FIG. 5 is another schematic view of the method for establishing a software augmented agent according to the first embodiment of the present disclosure.

In this embodiment, a method for establishing a software augmented agent is provided, the method is adapted to an electronic device ED1. The electronic device ED1 is connected to a display device DP1. The electronic device ED1 includes an application program APP1.

In this embodiment, the electronic device ED1 and the display device DP1 can be provided separately as a desktop computer, but are not limited thereto. The electronic device ED1 and the display device DP1 can also be provided together as a laptop computer or an all-in-one computer, but are not limited thereto.

At least one interaction interface AS1 of the application program APP1 is displayed on the display device DP1. The method for establishing a software augmented agent in this embodiment includes following steps:

Step S100: providing an augmented interface according to the interaction interface of the application program;

Step S110: displaying at least one augmented parameter of the augmented interface based on at least one interaction parameter of the interaction interface; and

Step S120: adjusting at least one augmented parameter of the augmented interface based on variations in a corresponding image of the at least one interaction parameter of the interaction interface.

In steps S100 and S110, after the application program APP1 is initialized, the application program APP1 in the electronic device ED1 provides a corresponding interaction interface AS1 to the display device DP1 for display. Then, an augmented application program EAPP1 in the electronic device ED1 is initialized, and an augmented interface EIF1 is provided to the display device DP1 for display.

As shown in FIG. 3 and FIG. 4, the augmented interface EIF1 is provided on the interaction interface AS1. The augmented interface EIF1 includes a first augmented dimension. The interaction interface AS1 includes an interaction dimension. In FIG. 2, the first augmented dimension of the augmented interface EIF1 is greater than or equal to the interaction dimension of the interaction interface AS1. In other embodiments, the first augmented dimension of the augmented interface EIF1 may be slightly smaller than the interactive dimension of the interaction interface AS1, but the augmented interface EIF1 is required to cover most of the interactive operation area of the interaction interface AS1.

In addition, a dimension of the interaction interface AS1 can be adjusted based on the practical requirements. Therefore, the first augmented dimension of the augmented interface EIF1 can also be adjusted based on the dimension of the interaction interface AS1.

The augmented interface EIF1 adjusts one or more augmented parameter EP1 of the augmented interface EIF1 based on the corresponding acquisition information of the interaction parameter ASP1 of the interaction interface AS1. In this embodiment, the interaction parameter ASP1 is a graphic user interfaces element (GUIs element), an image, a video, or an audio. Moreover, when the interaction parameter ASP1 is retrieved from a Graphic user interfaces element (GUIs element), the augmented interface EIF1 can continuously and periodically interact with the interaction parameter ASP1. That is, the augmented interface EIF1 can retrieve a certain degree of information from the interaction parameter ASP1 (e.g., a graphical user interface element), and can also provide one or more corresponding information of the interaction parameter ASP1 (e.g., a graphical user interface element) on the interaction interface AS1 by the augmented interface EIF1.

In this embodiment, the augmented interface EIF1 can be separated into multiple areas of the same size or different sizes, corresponding to areas of multiple interaction parameters ASP1 of the interaction interface AS1. In this embodiment, the corresponding acquisition parameters can include all graphical user interface elements of the interaction interface AS1, an image (such as a screenshot image), a video, or an audio, but are not limited thereto.

In this embodiment, the augmented application program EAPP1 will periodically or instantly determine whether or not the interaction parameter ASP1 changes. When the interaction parameter ASP1 changes, the augmented application program EAPP1 will adjust the augmented parameter EP1 based on the corresponding content obtained by the corresponding acquisition information.

Furthermore, the augmented interface EIF1 of the augmented application program EAPP1 will monitor and intercept input device events from a input device exemplarily including a mouse, a keyboard, a handwriting pad, and a trackpad, and transmit the normal operations of the input device to the interaction interface AS1 of the application program APP1 for normal operation.

The augmented interface EIF1 will not block an operation event of the input device on the interaction interface AS1. The augmented interface EIF1 will receive the operation event and provide the operation event, such that the operation is transmitted to the interaction interface AS1 for corresponding operations.

Furthermore, as shown in FIG. 4, the augmented interface EIF1 includes a plurality of operation icons EICON. When a movement icon of the input device exemplarily including a mouse, a keyboard, a stylus, or a trackpad is used to click one of the multiple operation icons EICON, the operation content corresponding to the operation icon EICON can be triggered. In this embodiment, each of the operation icons EICON including corresponding operation contents can be displayed or adjusted corresponding to the augmented parameter EP1, or can be displayed or adjusted in a customized manner based on the interaction parameter ASP1 on the interaction interface AS1 of the application program APP1, and is not limited in the present disclosure.

In other embodiments, the augmented application program EAPP1 can analyze the corresponding captured information through an image analysis circuit (not shown in the figure) of the electronic device ED1 to obtain the corresponding acquisition information and corresponding content, and further adjust the augmented parameter EP1 on the augmented interface EIF1. In this embodiment, various parameter calculations of the augmented application program EAPP1 can also be transmitted to a server (not shown in the figure) through a communication circuit (not shown in the figure) for calculation and then transmitted back to the electronic device ED1 for display.

It should be noted that, the augmented parameter EP1 of the augmented interface EIF1 can be expressed in texts or graphics.

In addition, in this embodiment, the augmented interface EIF1 may include multiple transparent areas and multiple operation areas. The multiple transparent areas of the augmented interface EIF1 display multiple display areas corresponding to the interaction interface AS1. The multiple operation areas of the augmented interface EIF1 are provided for a user to operate.

Referring to FIG. 5, in another embodiment, the augmented interface EIF1′ is disposed on one side of the interaction interface AS1. The augmented interface EIF1′ and the interaction interface AS1 are both displayed on the display device DP1.

At this time, the dimension of the augmented interface EIF1′ can be designed based on the practical requirements, and is not limited in the present disclosure.

In addition, the augmented interface EIF1′ at this time is not limited to be a transparent interface, and may include a fixed background color.

Furthermore, the underlying coding operations of the augmented application program EAPP1 and the application program APP1 are independent of each other. The augmented application program EAPP1 will not obtain the content of the interaction parameter ASP1 from the underlying coding of the application program APP1. That is, the augmented application program EAPP1 can only obtain the interaction parameter ASP1 of the interaction interface AS1 of the application program APP1 from the corresponding acquisition information of the corresponding interaction interface AS1.

### Second Embodiment

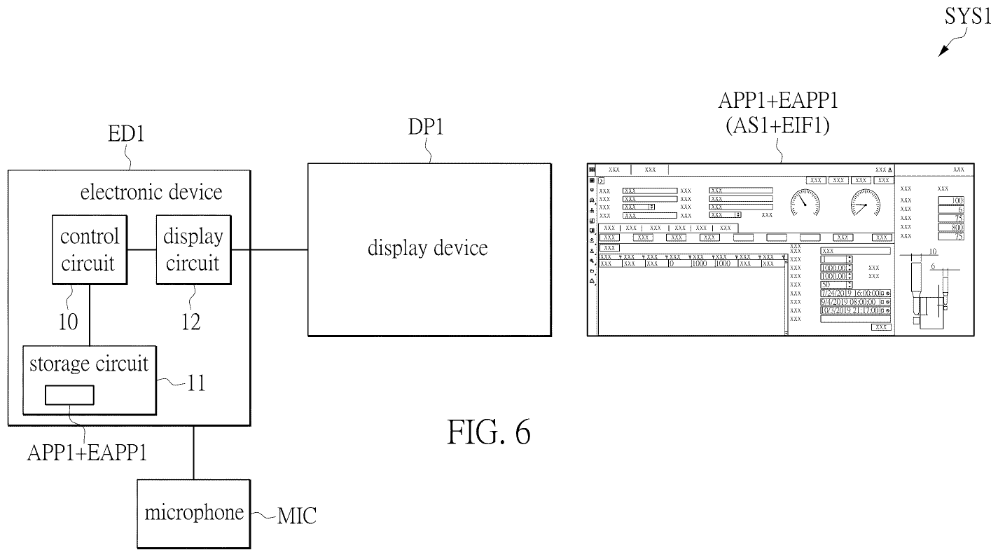

Referring to FIG. 6, a second embodiment of the present disclosure provides a software augmented agent system SYS1.

In this embodiment, the software augmented agent system SYS1 is adapted to an electronic device ED1.

The electronic device ED1 is connected to at least one display device DP1. The electronic device ED1 includes a control circuit 10, a storage circuit 11 and a display circuit 12. The electronic device ED1 also includes an application program APP1 provided in the storage circuit 11. The application program APP1 includes an interaction interface AS1. The control circuit 10 displays the interaction interface AS1 on the display device DP1 through the display circuit 12.

The software augmented agent system SYS1 includes an augmented application program EAPP1 provided in the storage circuit 11. The control circuit 10 displays an augmented interface EIF1 on the display device DP1 through the application program APP1 and the augmented application program EAPP1.

The augmented interface EIF1 and the interaction interface AS1 are both displayed on the display device DP1.

In this embodiment, the control circuit 10 controls the display circuit 12 to capture a corresponding acquisition information of the interaction interface AS1, so as to capture interaction parameters (not shown in the figure) of multiple information processing areas on the corresponding captured information of the interaction interface AS1. Each of the information processing areas includes at least one interaction parameter (not shown in the figure).

The interaction interface AS1 includes a plurality of interaction parameters (not shown in the figure). The augmented interface EIF1 adjusts one or more augmented parameters (not shown in the figure) of the augmented interface EIF1 based on one of the plurality of interaction parameters (not shown in the figure) of the interaction interface AS1.

The dimension and location of the augmented interface EIF1 can be designed based on different requirements as described in the first embodiment.

For example, the augmented interface EIF1 can be separated into multiple areas of the same size or different sizes, corresponding to areas of multiple interaction parameters (not shown in the figure) of the interaction interface AS1. In this embodiment, a captured image for image analysis can be exemplified as a captured image of the entire interaction interface AS1, or a captured image of the corresponding area of the interaction parameter (not shown in the figure) of part of the interaction interface AS1, and the present disclosure is not limited thereto. In this embodiment, the captured image is a form of the corresponding acquisition information.

The augmented interface EIF1 adjusts one or more augmentation parameters of the augmented interface EIF1 based on the interaction parameter of the corresponding acquisition information of the interaction interface AS1 (not shown in the figure).

In this embodiment, the augmented application program EAPP1 can analyze the corresponding acquisition parameters through a display circuit 12 of the electronic device EDI to obtain the corresponding acquisition parameters, and further adjust the augmented parameters (not shown in the figure) on the augmented interface EIF1. In this embodiment, the augmented application program EAPP1 can obtain the content corresponding to the acquisition information through the control circuit 10, the display circuit 12, or an audio circuit (not shown in the figure). That is, various information displayed by the application program APP1 through the electronic device ED1 can be obtained by the augmented application program EAPP1 for being used or calculated.

However, the underlying coding operations of the augmented application program EAPP1 and the application program APP1 are independent of each other. The augmented application program EAPP1 will not obtain the content of the interaction parameter (not shown in the figure) from the underlying code of the application program APP1. That is, the augmented application program EAPP1 can only obtain the interaction parameters (not shown in the figure) of the interaction interface AS1 of the application program APP1 from the corresponding acquisition information of the corresponding interaction interface AS1.

In other embodiments, the augmented application program EAPP1 will periodically or instantly determine whether or not the interaction parameter (not shown in the figure) changes. When the interaction parameter (not shown in the figure) changes, the augmented application program EAPP1 adjusts the augmented parameter based on the content corresponding to the acquisition information (not shown in the figure).

In addition, as shown in FIG. 6, the application program APP1 can receive an audio received by a microphone MIC. The microphone MIC is connected to the electronic device ED1. In addition to receiving the audio transmitted from the application program APP1, the control circuit 10 can also adjust the augmented parameter by analyzing the audio received by the microphone MIC.

### Third Embodiment

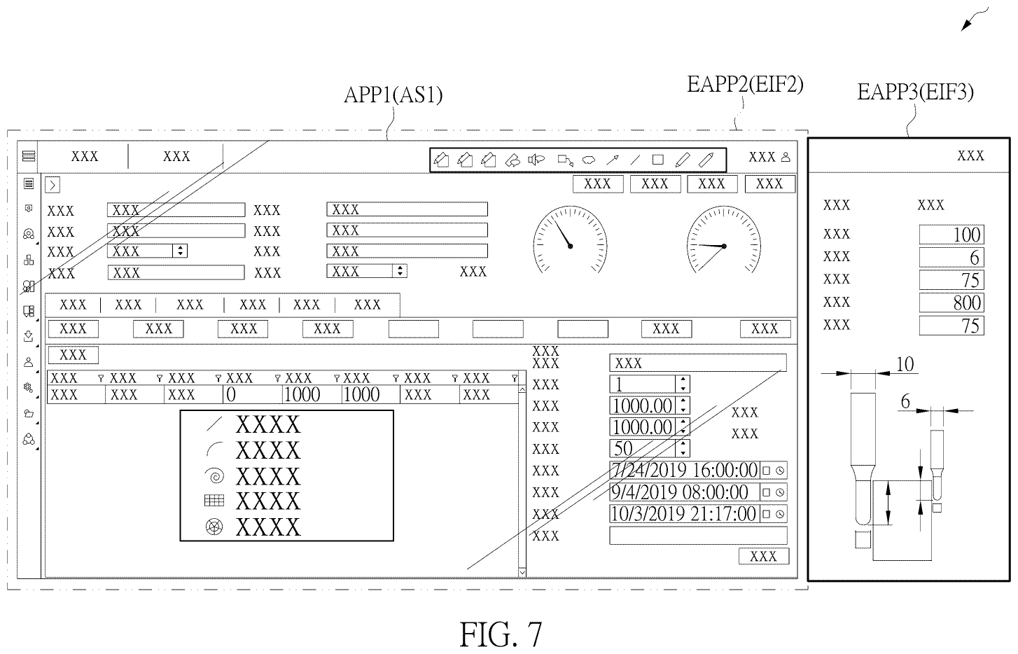

Referring to FIG. 7, FIG. 7 is a schematic view of a software augmented agent system according to a third embodiment of the present disclosure.

In this embodiment, a software augmented agent system SYS2 is provided. The difference between the software augmented agent system SYS2 and the software augmented agent system SYS1 of the second embodiment is that, the application program APP1 can cooperate with two augmented application programs EAPP2 and EAPP3. The software augmented agent system SYS2 is also applicable to the electronic device ED1 and the display device DP1 in the aforementioned embodiment, and structures and functions of the software augmented agent system SYS2 will be omitted herein for the sake of brevity.

In this embodiment, a first augmented interface EIF2 of a first augmented application program EAPP2 is superimposed on the interaction interface AS1 of the application program APP1. A second augmented interface EIF3 of a second augmented application program EAPP3 is arranged on one side of the interaction interface AS1.

In other embodiments, the application program APP1 can link more than two augmented application programs, numbers of the augmented application programs can be adjusted based on practical requirements, and the present disclosure is not limited thereto.

### Fourth Embodiment

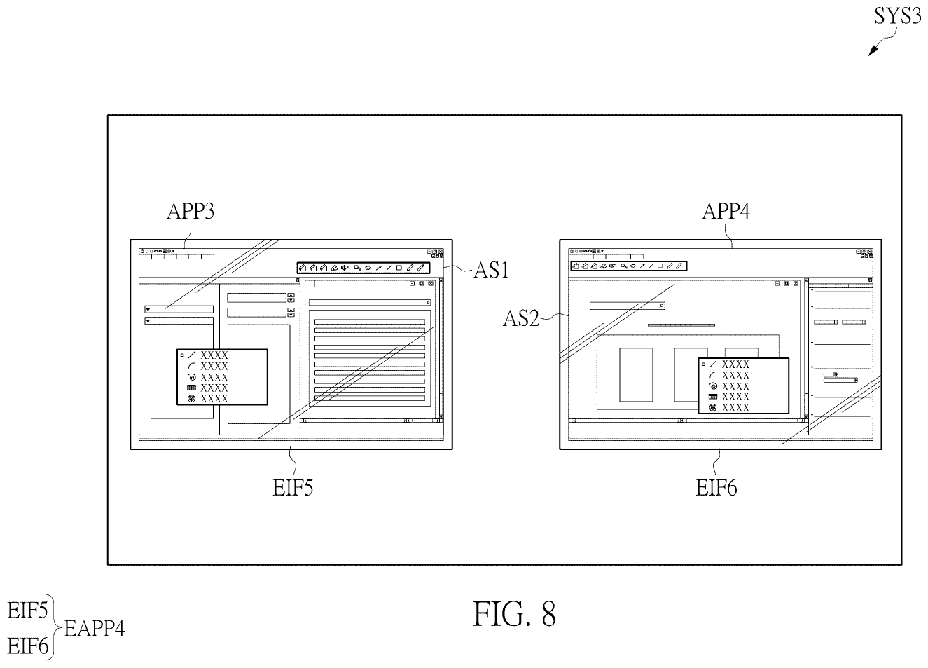

Referring to FIG. 8, FIG. 8 is a schematic view of a software augmented agent system according to a fourth embodiment of the present disclosure.

In this embodiment, a software augmented agent system SYS3 is provided. The different between the software augmented agent system SYS3, the software augmented agent system SYS1, and the software augmented agent system SYS2 is that, an augmented application program EAPP4 of the software augmented agent system SYS3 determines one or more augmented parameters of the augmented application program EAPP4 based on a first interaction parameter in a first application program APP3 and a second interaction parameter in a second application program APP4. In this embodiment, the augmented application program EAPP4 includes a first augmented interface EIF5 and a second augmented interface EIF6 that are respectively provided on the first application program APP3 and the second application program APP4.

In this embodiment, although the first augmented interface EIF5 is configured on the first application program APP3 and retrieves at least one interaction parameter of the first application program APP3, and the second augmented interface EIF6 is configured on the second application program APP4 and retrieves at least one interaction parameter of the second application program APP4, the augmented parameters on the first augmented interface EIF5 and the augmented parameters on the second augmented interface EIF6 can be determined based on the corresponding acquisition information that is acquired. In this embodiment, the first application program APP3 and the second application program APP4 may be different applications. For example, the first application program APP3 is a Solidworks® application program, and the second application program APP4 is a Pro/ENGINEER® application program.

### Beneficial Effects of the Embodiments

In conclusion, the method for establishing a software augmented agent and the software augmented agent system provided by the present disclosure are not necessary to communicate with the underlying code of the application program, by obtaining the corresponding acquisition information through the interaction interface of the application program, the augmented parameter of the augmented interface is determined. Furthermore, the method for establishing a software augmented agent and the software augmented agent system of the present disclosure can effectively improve the efficiency of software development and enhance the user experience.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for establishing a software augmented agent, being adapted to an electronic device, the electronic device being connected to a display device, the electronic device including an application program, at least one interaction interface of the application program being displayed on the display device, the method comprising:
providing an augmented interface based on the at least one interaction interface of the application program;
displaying at least one augmented parameter of the augmented interface based on at least one corresponding acquisition information of at least one interaction parameter of the at least one interaction interface; and
adjusting the at least one augmented parameter displayed on the augmented interface based on variations in the at least one corresponding acquisition information of the at least one interaction parameter of the at least one interaction interface.

2. The method according to claim 1, wherein the augmented interface does not block an operation event of an input device on the at least one interaction interface, and the augmented interface receives the operation event and provides the operation event to the at least one interaction interface to perform a corresponding operation; wherein the augmented interface adjusts the at least one augmented parameter of the augmented interfaces based on the corresponding acquisition information of the at least one interaction parameter of the at least one interaction interface.

3. The method according to claim 2, wherein the at least one interaction parameter is a graphic user interfaces element, an image, a video, or an audio.

4. The method according to claim 3, wherein the augmented interface includes a first augmented dimension, the at least one interaction interface includes an interaction dimension, and the first augmented dimension is greater than or equal to the interaction dimension of the at least one interaction interface; wherein the augmented interface is provided on the at least one interaction interface, and both of the augmented interface and the at least one interaction interface are displayed on the display device.

5. The method according to claim 4, wherein the augmented interface includes a plurality of transparent areas and a plurality of operation areas, and the plurality of transparent areas of the augmented interface display a plurality of display areas corresponding to the at least one interaction interface, and the plurality of display areas of the augmented interface are provided for a user to operate.

6. The method according to claim 2, wherein the augmented interface is provided on one side of the at least one interaction interface, and both of the augmented interface and the at least one interaction interface are displayed on the display device.

7. A software augmented agent system, being adapted to an electronic device, the electronic device being connected to at least one display device, the electronic device including a control circuit, a storage circuit, and a display circuit, the electronic device further including an application program provided in the storage circuit, the application program including an interaction interface, the control circuit displaying the interaction interface on the at least one display device through the display circuit, the software augmented agent system comprising:
an augmented application program being provided in the storage circuit;
wherein the control circuit displays an augmented interface on the at least one display device through the application program and the augmented application program;
wherein the augmented interface and the interaction interface are both displayed on the at least one display device.

8. The software augmented agent system according to claim 7, wherein the control circuit retrieves a corresponding acquisition information of at least one interaction parameter of the interaction interface, the at least one interaction parameter is a Graphic user interfaces element, an image, a video, or an audio, and the augmented interface adjusts one or more augmented parameters of the augmented interface based on the at least one interaction parameter of the interaction interface.

9. The software augmented agent system according to claim 8, wherein the augmented interface includes a first augmented dimension, the interaction interface includes an interaction dimension, and the first augmented dimension is greater than or equal to the interaction dimension of the interaction interface; wherein the augmented interface is provided on the interaction interface, and both of the augmented interface and the interaction interface are displayed on the display device.

10. The software augmented agent system according to claim 8, wherein the augmented interface is provided on one side of the interaction interface, and both of the augmented interface and the interaction interface are displayed on the display device.
